(19) United States
(12) Patent Application Publication
(10) Pub. No.: US 2009/0119526 A1
(43) Pub. Date: May 7, 2009

(54) ELECTRONIC SYSTEM AND POWER CONTROL METHOD THEREOF

(75) Inventors: Chia-Hsien Liu, Taichung City (TW); Wei-Jen Chen, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/934,947

(22) Filed: Nov. 5, 2007

(51) Int. Cl. G06F 1/32

(52) U.S. Cl. 713/323

(57) ABSTRACT

Electronic systems capable of entering a power saving mode even if a processing unit therein crashes are provided, in which a system core block comprises a processing unit. A power control block, operating in a different power domain than the system core block comprises a power control logic circuit, which sends an enabling signal to a power supply to power down the system core block according to a triggering signal.

### BACKGROUND OF THE INVENTION

1. Field of the Invention

The invention relates to power management, and in particular to an electronic system capable of entering a power saving mode even in the event of CPU crash.

2. Description of the Related Art

Power consumption is a vital issue for many battery-powered consumer electronic devices. It is therefore desirable to extend the operational battery life of these portable systems, either through improved battery technology or more energy-efficient components.

A conventional method to extend battery time on a portable electronic device utilizes a power saving (i.e. sleep) mode. After a certain amount of time has passed during which the device has remained idle, the central processing unit (CPU) saves the state of the device into memory and enters a suspend state that consumes relatively little power. In most systems, a CPU manages the power saving procedure. However, the system cannot enter the power saving mode when the CPU crashes.

### BRIEF SUMMARY OF THE INVENTION

The invention provides an embodiment of an electronic system, the electronic system comprises a system core block having a processing unit, and a power control block having a power control logic circuit and a counter. The power control logic circuit, according to a triggering signal, sends an indicating signal to the CPU and an enabling signal. The counter counts for a predetermined time interval upon receiving the enabling signal from the power control logic circuit, and outputs a first signal to turn off power of the system core block if no reset signal is received during a predetermined time interval.

The invention also provides an embodiment of a power control method, in which a triggering signal is received and a logic combination or key matching is executed upon the triggering signal to determine if a predetermined condition has occurred. A power down signal is output to turn off power of the system core block when the predetermined condition has been met.

The invention provides another embodiment of a power control method, in which a triggering signal is received and a logic combination or key matching is executed upon the trigger signal to determine if a predetermined condition has been met. An indicating signal is output to a processing unit in the system core block and/or an enabling signal is output to a counter in the power control block when the predetermined condition has been met. A predetermined time interval is calculated upon receipt of the enabling signal, and power of the system core block is turned off upon receipt of no calculating reset signal from the CPU during the predetermined time interval.

### BRIEF DESCRIPTION OF THE DRAWINGS

The invention can be more fully understood by reading the subsequent detailed description and examples with references made to the accompanying drawings, wherein:

FIG. 1 shows an embodiment of an electronic system;

FIG. 2 shows another embodiment of an electronic system;

FIG. 3 is an exemplary flowchart of a power control method for the electronic system shown in FIG. 2;

FIG. 4 shows another embodiment of an electronic system;

FIG. 5 is a flowchart of a power control method according to the electronic system shown in FIG. 4;

FIG. 6 shows another embodiment of an electronic system;

FIG. 7 is an exemplary flowchart of a power control method for the electronic system shown in FIG. 6;

FIG. 8 shows another embodiment of an electronic system; and

FIG. 9 shows another embodiment of an electronic system.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

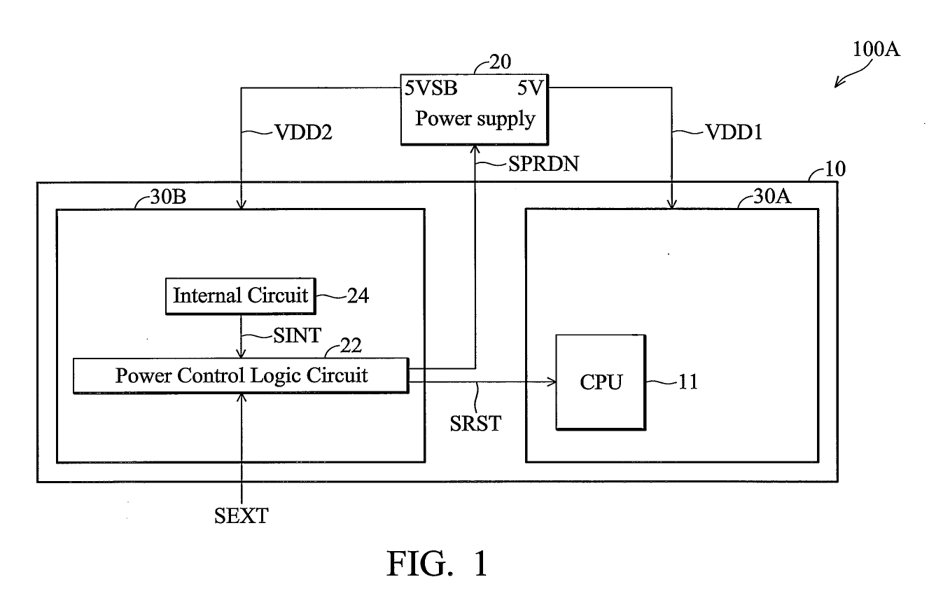

FIG. 1 shows an embodiment of an electronic system according to the invention. The electronic system 100A can be implemented in digital cameras, digital recorder (DVRs), consumer or office appliances, cell phones, PDAs, or other handheld devices as well as robots, but is not limited thereto. The electronic system 100A comprises an integrated circuit 10 and a power supply 20, in which the integrated circuit 10 can be a chip and comprises system core block 30A and power control block 30B. The two blocks 30A and 30B are arranged in different power domains, and the power supply 20 provides voltages VDD1 and VDD2, such as +5VSB and +5V, to power the system core block 30A and the power control block 30B respectively. In some other embodiments, the voltage source of the power control block 30B is not the same as the source of the system core block 30A, which is the power supply 20, VDD1 is provided by another power supply.

The system core block 30A provides multiple functions according to different commands and comprises a central processing unit (CPU) 11, a system bus (not shown), an internal memory unit (not shown), a direct memory access (DMA) controller (not shown), a DRAM controller (not shown) and the like. The CPU 11 performs computational routines and controls the entire system based on executing a program, and the CPU 11 can be replaced by a microprocessing unit (MPU), a digital signal processor, a microprocessor, or multiple processing units. In this embodiment, the electronic system 100A can be operated in a normal mode, a power saving (standby or sleep) mode, or the like. In the normal mode, the power supply 20 powers the system core block 30A and the power control block 30B, but the power supply 20 stops powering the system core block 30A and continues powering the power control block 30B, i.e. only the voltage VDD2 is provided to the power control block 30B, in the power saving mode.

The power supply 20 controls power supplied to the system core block 30A, and resets the CPU 11 according to an internal signal SINT and an external signal SEXT. The power control block 30B comprises a power control logic circuit 22 and an internal circuit 24. The power control logic sends a power down signal SPRDN to control the power supply 20 to stop powering the system core block 30 (i.e. entering power saving mode) and/or a reset signal SRST to the CPU 11 to reset the entire system 100A. For example, the internal circuit 24 can be a real time counter (RTC) to generate a triggering signal to serve as the internal signal SINT when a predetermined time expires, but is not limited thereto.

The power control logic circuit 22 receives the internal signal SINT from the internal circuit 24 or the external signal SEXT, and executes logic combination or key matching to determine the power down signal SPRDN output to the power supply 20. For example, after receiving the external signal SEXT or the internal signal SINT, the power control logic circuit 22 executes logic combination or key matching, returns to an idle state if the condition has not been met. If the condition has been met, the power control logic circuit 22 outputs the power down signal SPRDN to command the power supply 20 stops powering the system core block 30 (i.e. entering power saving mode directly). Alternately, the power control logic circuit 22 outputs the reset signal SRST to the CPU 11 to reset the entire system 100A when the condition has been met.

Note that the power control logic circuit 22 is a digital logic circuit composed of logic gates comprising AND gates, OR gates, NOT gates, NAND gates, NOR gates and/or EX-OR gates, rather than a microprocessing unit (MPU), a digital signal processor, a microcontroller, a central processing unit, or a microprocessor that can execute instructions or commands programmed in a program stored in a storage device, such as a flash memory or a DRAM. The power control logic circuit 22 is a non-programmable hardware circuit designed especially for power control. Thus, the electronic system 100A consumes much less power than that comprising a programmable processor or controller.

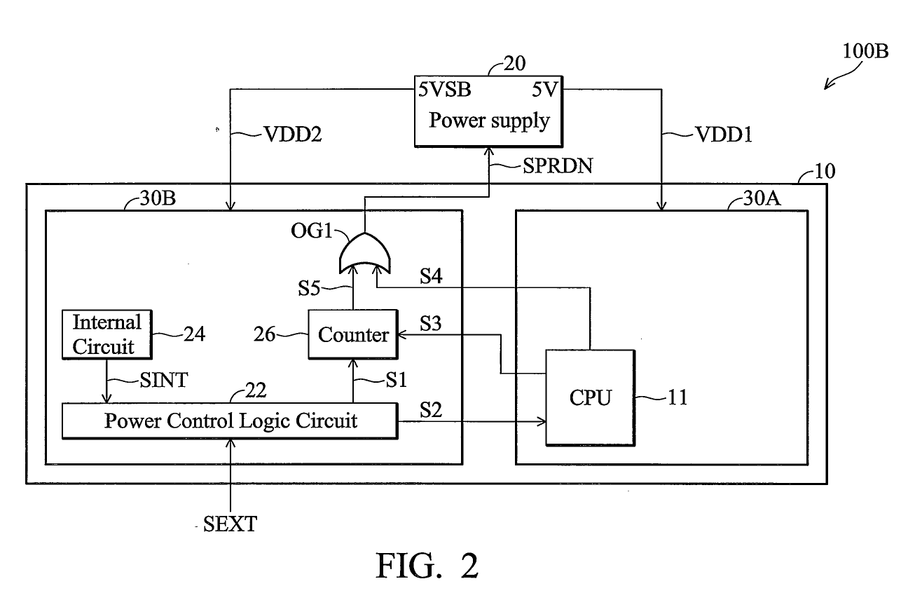

FIG. 2 shows another embodiment of an electronic system. As shown, an electronic system 100B is similar to electronic system 100A shown in FIG. 1, differing only in that the power control block 30B further comprises a counter 26 and an OR gate OG1, and the power control logic circuit 22 does not output the power down signal SPRDN directly but rather triggers the counter 26.

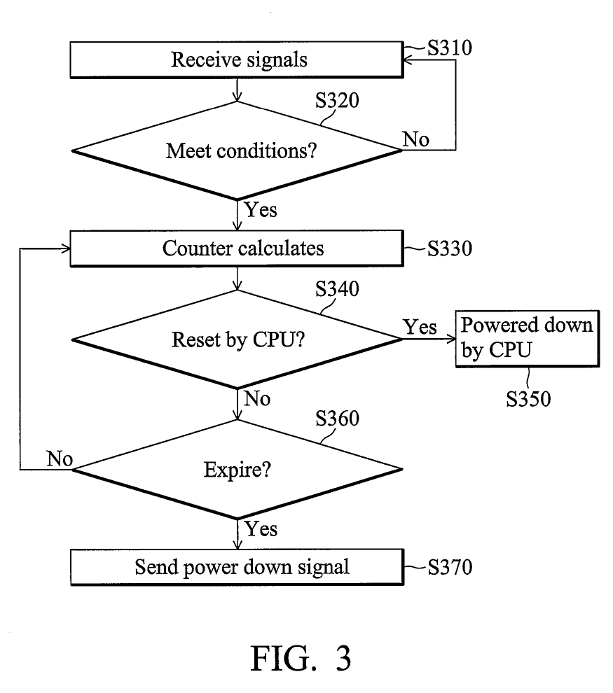

FIG. 3 is a flowchart of an exemplary power control method for the electronic system shown in FIG. 2. Operations of the electronic system 100B are described with reference to FIGS. 2 and 3.

In step S310, the power control logic circuit 22 receives an internal signal SINT from the internal circuit 24 or an external signal SEXT. Power control logic circuit then executes logic combination or key matching to determine an enable signal S1 and a reset request indicating signal S2 in step S320. If the condition has not been met, the process returns to the step S310 and the power control logic circuit 22 continues receiving the internal signal SINT or external signal SEXT. If the condition has been met, the power control logic circuit 22 outputs an enable signal S1 to the counter 26 and a reset indication signal S2 to the CPU 11. In step S330, the counter 26 starts for a predetermined time interval upon receipt of the enable signal S1.

Step S340 determines whether the counter 26 is reset by the CPU 11. For example, if the CPU 11 is operated normally (i.e., awake), the CPU 11 is responsible for system power down, so a reset signal S3 is output to reset the counter 26 upon receipt of the reset indicating signal S2, and then step S350 is executed to power down the system 110B. If the CPU 11 crashes, the counter 26 is not reset by the CPU 11 and will keep counting until expiring.

In step S350, according to the reset indicating signal S2, the CPU 11 executes a power down program so the electronic system 100B enters power saving mode by software. For example, the CPU 11 outputs a signal S4 to the OR gate OG1 and OR1 outputs the power down signal SPRDN to the power supply 20. The power supply 20 stops powering the system core block 30A according to the power down signal SPRDN. Hence, the system 100B enters the power saving mode.

In step S360, whether the predetermined time interval for the counter 26 has expired is determined. If the CPU 11 crashes, the counter 26 can not be reset by the CPU 11, so the counter 26 continues counting. If the predetermined time interval expires, step S370 is executed to enter power saving mode by hardware.

In step S370, the counter 26 outputs a signal S5 to the OR gate OG1, and OG1 outputs the power down signal SPRDN to the power supply 20. The power supply 20 stops powering the system core block 30A according to the power down signal SPRDN. Hence, the system 100B enters the power saving mode.

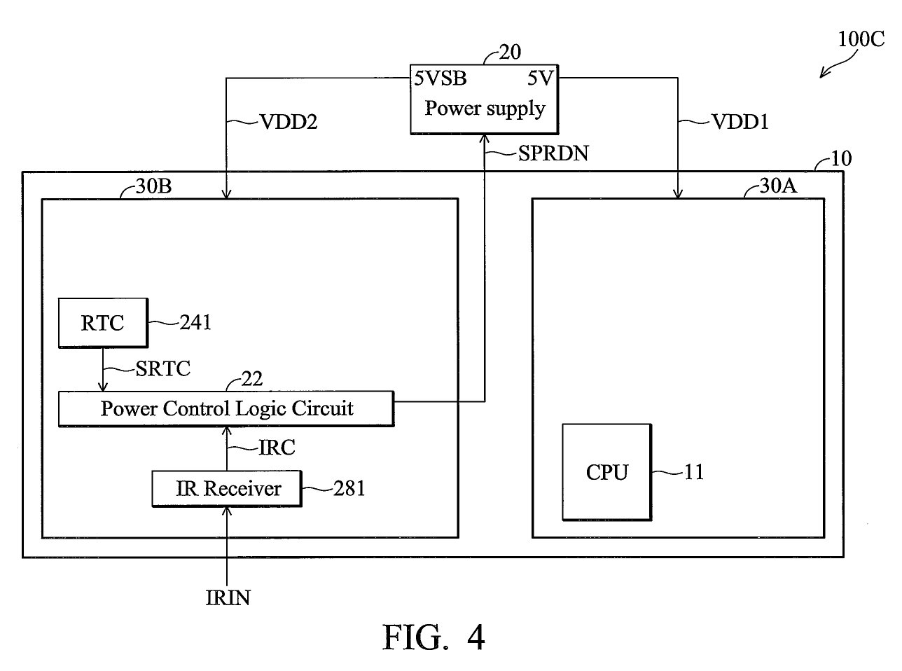

FIG. 4 shows another embodiment of an electronic system. As shown, an electronic system 100C is similar to electronic system 100A shown in FIG. 1, differing only in that a real time counter (RTC) 241 serves as the internal circuit 24 and an infrared (IR) receiver 281 receives an IR input signal IRIN (i.e. the external signal SEXT) from an external IR device (not shown).

The real time counter 241 outputs a triggering signal SRTC (i.e. the internal signal SINT) for triggering the power control logic circuit 22 to output the power down signal SPRDN to the power supply 20. For example, a time reservation can be set by the CPU 11. When the real time counter 251 matches the time set by the CPU 11, the real time counter 251 outputs the signal SRTC (i.e. the internal signal SINT) to the power control logic circuit 22. Hence, the power control logic circuit 22 outputs the power down signal SPRDN to the power supply 20, such that the power supply 20 stops powering the system core block 20A (i.e. entering power saving mode).

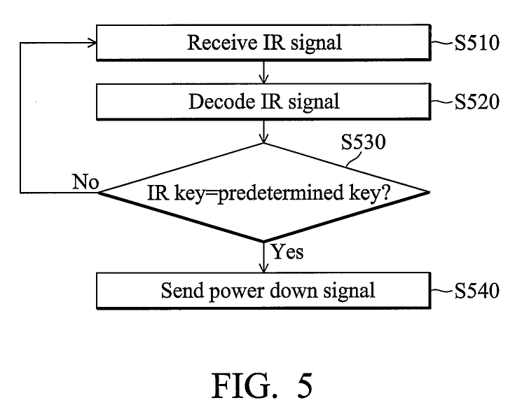

FIG. 5 is a flowchart of a power control method according to the electronic system shown in FIG. 4. Operations of the electronic system 100C are described with reference to FIGS. 4 and 5.

In step S510, the IR receiver 281 receives an IR input signal IRIN (i.e. the external signal SEXT) from an external IR device (not shown). In step S520, the receiver 281 decodes the IR input signal IRIN and outputs IR code (key) IRC to the power control logic circuit 22. In step S530, the power control logic circuit 22 executes logic combination or key matching to determined if the IR code (key) IRC matches a predetermined code. The predetermined IR code, for example, can be set to the power control logic circuit 22 by the CPU 11. If the IR code IRC is different from the predetermined IR code, the process returns to step S510. On the contrary, if the power control logic circuit 22 finds that the received IR code IRC matches the predetermined code set by the CPU 11, the power control logic circuit 22 outputs the power down signal SPRDN to the power supply 20 in step S540, such that the power supply 20 stops powering the system core block 20A (i.e. entering power saving mode).

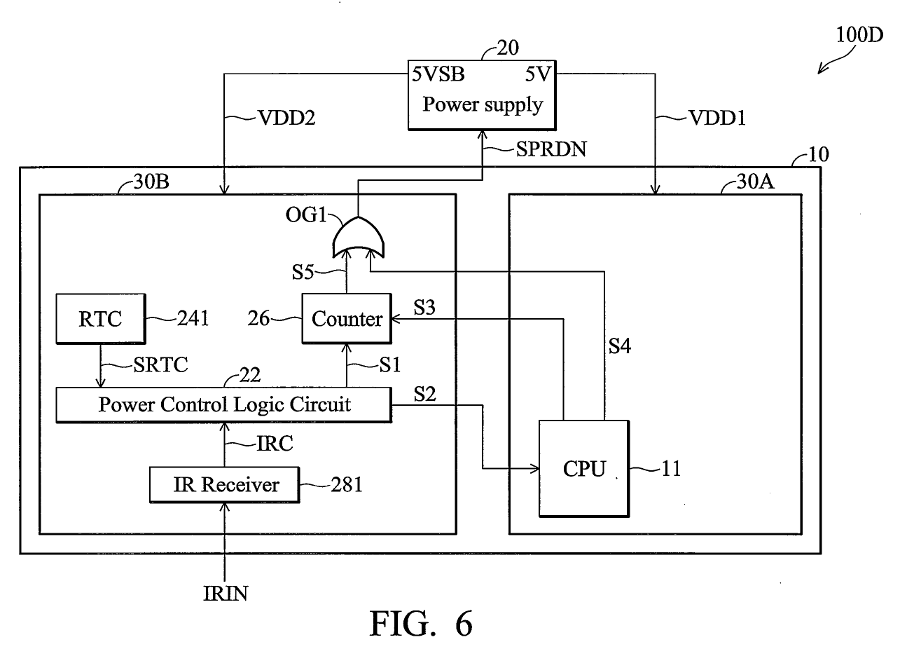

FIG. 6 shows another embodiment of an electronic system. As shown, an electronic system 100D is similar to electronic system 100B shown in FIG. 2, differing only in that a real time counter (RTC) 241 serves as the internal circuit 24 and an infrared (IR) receiver 281 receives an IR input signal IRIN from an external IR device (not shown). The real time counter 241 outputs a triggering signal SRTC (i.e. the internal signal SINT) for triggering the power control logic circuit 22 to output the power down signal SPRDN to the power supply 20.

Upon receipt of the triggering signal SRCT from the internal circuit 24, the power control logic circuit 22 executes logic combination or key matching to determine output of an enable signal S1 and a reset request indicating signal S2. When the condition has been met, the power control logic circuit 22 outputs an enable signal S1 to the counter 26 and a reset indication signal S2 to the CPU 11. Consequently, the counter 26 starts to count a predetermined time interval upon receipt of the enable signal S1. If the CPU 11 is operated normally (i.e., awake), it outputs a reset signal S3 to reset the counter 26. Consequently, the CPU 11 executes a power down program to force the electronic system 100B to enter power saving mode by software. For example, the CPU 11 outputs a signal S4 to the OR gate OG1. OG1 thus outputs the power down signal SPRDN to the power supply 20. The power supply 20 stops powering the system core block 30A according to the power down signal SPRDN.

On the contrary, if the CPU 11 crashes, it cannot output the signal S3 to reset the counter 26. The counter 26 keeps counting until reaching the predetermined time interval. When the predetermined time interval expires, the counter 26 outputs a signal S5 such the OR gate OG1 outputs the power down signal SPRDN. Consequently, the power supply 20 stops powering the system core block 30A according to the power down signal SPRDN and the system 100B enters the power saving mode.

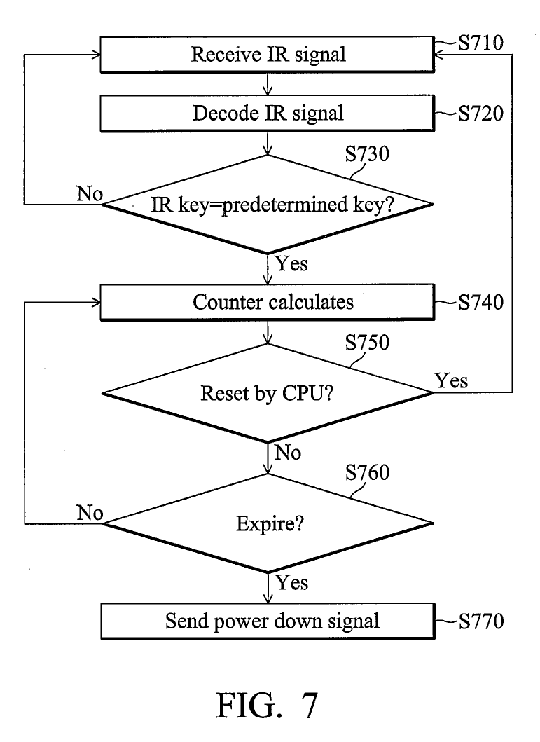

FIG. 7 is a flowchart of a power control method according to the electronic system shown in FIG. 6. Operations of the electronic system 100D are described with reference to FIGS. 6 and 7.

In step S710, the IR receiver 281 receives an IR input signal IRIN from an external IR device. In step S720, the IR receiver 281 decodes the IR input signal IRIN and outputs IR code (key) IRC to the power control logic circuit 22. In step S730, the power control logic circuit 22 executes logic combination or key matching to determined if the IR code (key) IRC matches a predetermined code. If the IR code IRC is different from the predetermined IR code, the process returns to step S710.

On the contrary, if the power control logic circuit 22 finds that the received IR code IRC matches the predetermined code set by the CPU 11, the power control logic circuit 22 outputs an enable signal S1 to activate the counter 26 to count for a predetermined time interval, and the power control logic circuit 22 also outputs a reset indication signal S2 to the CPU 11 in step S740.

In step S750, whether the counter 26 is reset by the CPU 11 is determined. For example, if the CPU 11 is operated normally (i.e., awake), power down is performed by executing a power down software, and the CPU 11 outputs a signal S4 to OG1 and a reset signal S3 to the counter 26. The power supply 20 stops powering the system core block 30A upon receiving the power down signal SPRDN.

If the CPU 11 crashes, it cannot output a signal S3 to reset the counter 26 and then step 760 is executed. In step S760, whether the predetermined time interval has expired is determined. Once the CPU 11 crashes, the counter 26 is not reset thereby and the counter 26 continues counting until reaching the predetermined time interval. The counter 26 then outputs a signal S5 such that OR gate OG1 outputs the power down signal SPRDN (in step S370), and the power supply 20 stops powering the system core block 30A.

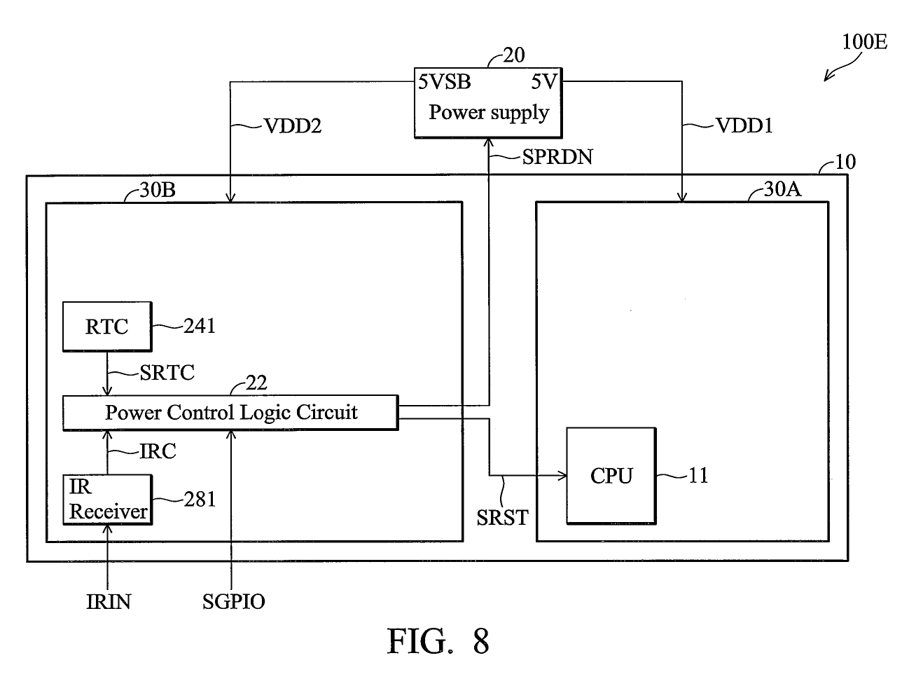

FIG. 8 shows another embodiment of an electronic system. As shown, an electronic system 100E is similar to electronic system 100C shown in FIG. 4, differing only in that the power control logic circuit 22 can be triggered by not only the triggering signal SRTC from the real time counter 281 and the IR input signal IRIN but also a trigger signal SGPIO (i.e. the external signal SEXT) from a communication port (not shown). The signal SGPIO, for example, can be generated by an external device (not shown) and transmitted to the power control logic circuit 22 through the communication port, thereby instructing the electronic system 100E to enter into the power saving mode. Operations enabling the power control logic circuit 22 to output the power down signal SPRDN by any of the internal or external triggering signals are similar to those shown in FIG. 4 and thus are omitted for simplification.

In this embodiment, the power control logic circuit 22 can be triggered to output the power down signal SPRDN to the power supply 20 by the signal SGPIO from a communication port. For example, the communication port can be a general purpose input/output (GPIO) port or a RS232 port, but is not limited thereto. Upon receipt of the signal SGPIO, the power control logic circuit 22 outputs the power down signal SPRDN to the power supply 20, such that the power supply 20 stops powering the system core block 20A (i.e. entering power saving mode). In this embodiment, the signals IRIN, and GPIO are regarded as external signals from external devices (not shown) and the triggering signals STRC are regarded as internal signals.

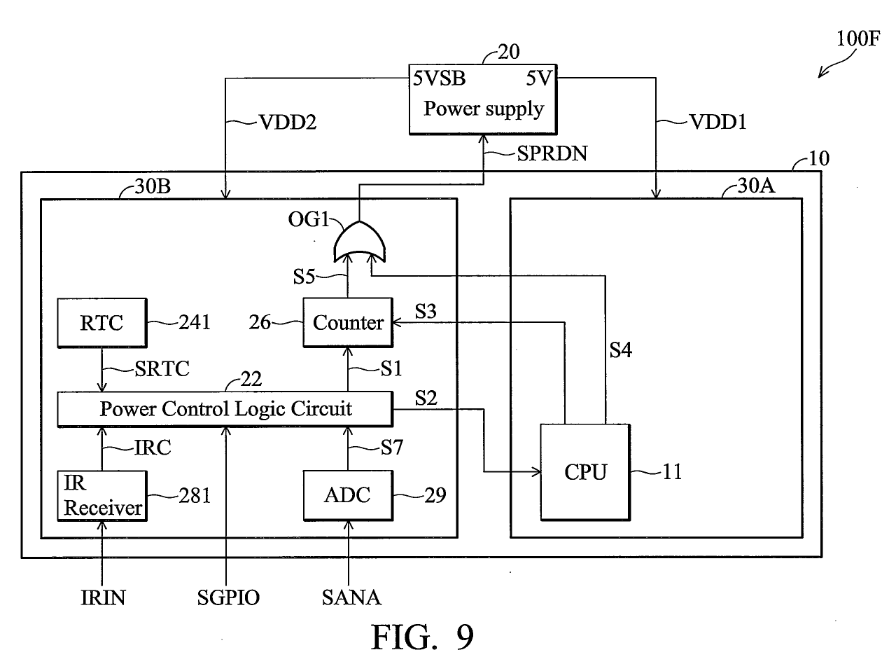

FIG. 9 shows another embodiment of an electronic system 100F, similar to electronic system 100E shown in FIG. 8, differing only in that the power control block 30B further comprises a counter 26 and an OR gate OG1 and the power control logic circuit 22 does not outputs the power down signal SPRDN directly but triggers the counter 26 instead.

The power control logic circuit 22 receives the internal signal SRTC, the IR code IRC, the triggering signal SGPIO and the signal S7 generated based on an analog signal SANA, then it executes logic combination or key matching to determine output of an enable signal S1 and a reset request indicating signal S2. For example, the analog signal SANA can be a temperature detection signal or voice signal but is not limited thereto.

When the condition has been met, the power control logic circuit 22 outputs an enable signal S1 to the counter 26 and a reset indication signal S2 to the CPU11. For example, upon receipt of the analog signal SANA, the analog-to-digital converter (ADC) 29 converts it to a corresponding signal S7 (i.e. the triggering signal) and outputs to the power control logic circuit 22. The power control logic circuit 22 then executes logic combination or key matching on the signal S7 and outputs the enable signal S1 to the counter 26 and the reset indication signal S2 to the CPU11 when predetermined conditions are met. For example, when the result of speech recognition indicates the signal S7 (i.e., the signal SANA) matches a predetermined key, the power control logic circuit 22 outputs the enable signal S1 to the counter 26 and the reset indication signal S2 to the CPU11.

Upon receipt of the enable signal St, the counter 26 starts to count for a predetermined time interval. If the CPU 11 is operated normally (i.e., awake), the CPU 11 outputs a reset signal S3 to reset the counter 26 upon receipt of the reset indicating signal S2. The CPU 11 executes a power down program to make the electronic system 100F entering power saving mode by software. The CPU 11 outputs a signal S4, such that the OR gate OG1 outputs the power down signal SPRDN to the power supply 20. The power supply 20 then stops powering the system core block 30A according to the power down signal SPRDN, such that the system 100B enters the power saving mode.

If the CPU 11 crashes, it cannot reset the counter 26 and the counter 26 continues counting until reaching the predetermined time interval. When the predetermined time interval expires, the counter 26 outputs a signal S5 such the OR gate OG1 outputs the power down signal SPRDN. Consequently, the power supply 20 stops powering the system core block 30A according to the power down signal SPRDN, such that the system 100B enters the power saving mode.

Because the power control logic circuit can power off the system core block when the central processing unit does not reply during a predetermined time interval, the electronic systems in the embodiments can enter a power saving mode even if the central processing unit crashes. In addition, because the power control logic circuit in the embodiments can be a digital logic circuit without a microprocessing unit (MPU), a digital signal processor, a microcontroller, a central processing unit, or a microprocessor that can execute instructions or commands programmed in a program stored in a storage device. Thus, the electronic systems of the embodiments consume much less power than that comprising a microprocessing unit (MPU), a digital signal processor, a microcontroller, a central processing unit, or a microprocessor.

In some other embodiments, the power down signal is sent to the power domain 30A to reset the CPU 11 in order to recover the system. For example, when the CPU 11 is working abnormally, the counter 26 will not be reset by the CPU 11, and the counter 26 issues a power down signal to the CPU 11 to reset the CPU 11. The power down signal may also be sent to the power supply 20 to command the system 100F entering the power saving mode.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic system, comprising:
a system core block comprising a processing unit;
a power supply, providing power to the system core block; and
a power control logic circuit commanding the power supply to power down the system core block according to a triggering signal;
wherein the power control logic circuit and the system core block are in different power domains.

2. The electronic system as claimed in claim 1, wherein the power control logic circuit is non-programmable.

3. The electronic system as claimed in claim 1, wherein the power control logic circuit executes a logic combination or a key matching to determine whether to command the power supply to power down the system core block.

4. The electronic system as claimed in claim 1, wherein the power supply stops powering the system core block upon receipt of a power down signal from the power control logic circuit.

5. The electronic system as claimed in claim 1, wherein the triggering signal is from an external device through a communication port.

6. The electronic system as claimed in claim 1, further comprising a real time counter generating the triggering signal.

7. The electronic system as claimed in claim 1, further comprising an infrared (IR) receiver generating the triggering signal based on a received IR signal.

8. The electronic system as claimed in claim 1, further comprising an analog-to-digital converter (ADC) generating the triggering signal based on a received analog signal.

9. The electronic system as claimed in claim 1, wherein the power supply also provides power to the power control logic circuit.

10. The electronic system as claimed in claim 1, wherein the power control logic circuit reset the processing unit according to the triggering signal.

11. The electronic system as claimed in claim 1, further comprising:
a counter set to count for a predetermined time interval upon receipt of an enabling signal from the power control logic circuit, and outputting a first signal to command the power supply to power down the system core block if not receiving a reset signal from the processor unit during the predetermined time interval;
Wherein the power control logic circuit sends an indicating signal to the processing unit and the enabling signal to the counter according to the triggering signal and the processing unit sends the reset signal to the counter upon receipt of the indicating signal if operating in a normal mode.

12. The electronic system as claimed in claim 11, wherein the processing unit executes a power down program and outputs a second signal to command the power supply to power down the system core block if operating in a normal mode.

13. A power control method for an electronic system comprising a system core block and a power control block, comprising:
receiving a triggering signal by the power control block;
executing logic combination or key matching to the triggering signal to determine if a predetermined condition has been met; and
commanding a power supply to power down the system core block when the predetermined condition has been met;
wherein the system core block and the power control block are in different power domain.

14. The power control method as claimed in claim 13, further comprising the power control block sending a reset signal to reset a processing unit in the system core block.

15. The power control method as claimed in claim 13, comprising:
counting for a predetermined time interval when the predetermined condition has been met; and
if the processing unit is operating in a normal mode, stop counting and powering down the system core block by the processing unit, else powering down the system core block by the power control block when counting to the predetermine time interval.

16. The power control method as claimed in claim 15, wherein the processing unit sends an indicating signal to stop counting, executing a power down program to turn off the system core block if operating in a normal mode.

17. The power control method as claimed in claim 13, wherein the triggering signal comprises an internal signal or an external signal requesting the system core block entering a power saving mode.
